(19) United States
(12) Patent Application Publication
(10) Pub. No.: US 2026/0067776 A1
(43) Pub. Date: Mar. 5, 2026

(54) ROAMING SUPPORT IN WLANS

(71) Applicant: Samsung Electronics Co., Ltd., Suwon-si (KR)

(72) Inventors: Peshal Nayak, Plano, TX (US); Bilal Sadiq, Plano, TX (US); Boon Loong Ng, Plano, TX (US); Rubayet Shafin, Frisco, TX (US); Yue Qi, Plano, TX (US); Vishnu Vardhan Ratnam, Frisco, TX (US)

(21) Appl. No.: 19/317,061

(22) Filed: Sep. 2, 2025

Related U.S. Application Data
(60) Provisional application No. 63/691,069, filed on Sep. 5, 2024.
(60) Provisional application No. 63/697,222, filed on Sep. 20, 2024.
(60) Provisional application No. 63/730,651, filed on Dec. 11, 2024.
(60) Provisional application No. 63/751,930, filed on Jan. 31, 2025.
(60) Provisional application No. 63/802,377, filed on May 8, 2025.
(60) Provisional application No. 63/838,372, filed on Jul. 3, 2025.

(51) Int. Cl. H04W 36/18; H04W 8/08; H04W 36/00; H04W 36/30

(52) U.S. Cl. CPC H04W 36/18; H04W 8/08; H04W 36/0011; H04W 36/304

(57) ABSTRACT

A station (STA) includes a processor, and a transceiver operably coupled to the processor. The transceiver is configured to transmit, to a target access point (AP), an execution request message, and receive, from the target AP, an execution response message. The target AP is part of a seamless roaming mobility domain of a current AP of the STA.

### CROSS-REFERENCE TO RELATED APPLICATION(S) AND CLAIM OF PRIORITY

This application claims priority under 35 U.S.C. § 119 (e) to U.S. Provisional Patent Application No. 63/691,069 filed on Sep. 5, 2024, U.S. Provisional Patent Application No. 63/697,222 filed on Sep. 20, 2024, U.S. Provisional Patent Application No. 63/730,651 filed on Dec. 11, 2024, U.S. Provisional Patent Application No. 63/751,930 filed on Jan. 31, 2025, U.S. Provisional Patent Application No. 63/802,377 filed on May 8, 2025, and U.S. Provisional Patent Application No. 63/838,372 filed on Jul. 3, 2025. The above-identified provisional patent applications are hereby incorporated by reference in their entirety.

### TECHNICAL FIELD

This disclosure relates generally to wireless networks. More specifically, this disclosure relates to roaming support in wireless local area networks (WLANs) including next generation WLANs.

### BACKGROUND

WLAN technology allows devices to access the internet in the 2.4 GHZ, 5 GHZ, 6 GHZ or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for roaming support in WLANs.

In one embodiment, a station (STA) is provided. The STA includes a processor, and a transceiver operably coupled to the processor. The transceiver is configured to transmit, to a target access point (AP), an execution request message, and receive, from the target AP, an execution response message. The target AP is part of a seamless roaming mobility domain of the STA.

In another embodiment, an AP is provided. The AP includes a processor, and a transceiver operably coupled to the processor. The transceiver is configured to receive, from a STA, an execution request message, and transmit, to the STA, an execution response message. The AP is part of a seamless roaming mobility of current AP of the STA.

In yet another embodiment, an AP provided. The AP includes a processor, and a transceiver operably coupled to the processor. The transceiver is configured to receive, from a target AP of a STA, a preparation request message, and transmit, to the target AP of the STA, a preparation response message. The AP is a current AP of the STA, and the target AP is part of a seamless roaming mobility domain of the AP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following documents and standards descriptions are hereby incorporated into the present disclosure as if fully set forth herein: [1] IEEE P802.11be/D7.0, 2024; and [2] IEEE Std 802.11-2020.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example wireless network where infrastructure traffic and non-infrastructure traffic coexist according to embodiments of the present disclosure;

FIG. 4 illustrates an example SCS request frame format according to embodiments of the present disclosure;

FIG. 5 illustrates an example of an uplink data pause according to embodiments of the present disclosure;

FIG. 6 illustrates an example call flow of a context pull feasibility check performed after roaming according to embodiments of the present disclosure;

FIG. 7 illustrates an example call flow of a context pull feasibility check performed after roaming with a re-setup for one or more features according to embodiments of the present disclosure;

FIG. 8 illustrates an example call flow of a context pull feasibility check performed prior to roaming according to embodiments of the present disclosure;

FIG. 9 illustrates an example call flow of a context pull feasibility check performed as part of the roaming procedure according to embodiments of the present disclosure;

FIG. 10 illustrates an example independent bit based indication according to embodiments of the present disclosure;

FIG. 11 illustrates an example bit based indication for pulled context according to embodiments of the present disclosure;

FIG. 12 illustrates an example frame format for pulled context indication according to embodiments of the present disclosure;

FIG. 13 illustrates an example downlink skip indication procedure according to embodiments of the present disclosure;

FIG. 14 illustrates an example roam phase indication procedure according to embodiments of the present disclosure;

FIG. 15 illustrates an example roam phase skip indication call flow according to embodiments of the present disclosure;

FIG. 16 illustrates another example roam phase indication call flow according to embodiments of the present disclosure;

FIG. 17 illustrates an example pre-roam phase indication procedure according to embodiments of the present disclosure;

FIG. 18 illustrates an example pre-roam phase skip indication call flow according to embodiments of the present disclosure;

FIG. 19 illustrates another example pre-roam phase skip indication call flow according to embodiments of the present disclosure;

FIG. 20 illustrates an example request-response based indication procedure according to embodiments of the present disclosure;

FIG. 21 illustrates a STA response to an AP's rejection procedure according to embodiments of the present disclosure;

FIG. 22 illustrates an example method for seamless roaming support in next generation WLANs according to embodiments of the present disclosure;

FIG. 23 illustrates another example method for seamless roaming support in next generation WLANs according to embodiments of the present disclosure; and

FIG. 24 illustrates another example method for seamless roaming support in next generation WLANs according to embodiments of the present disclosure.

### DETAILED DESCRIPTION

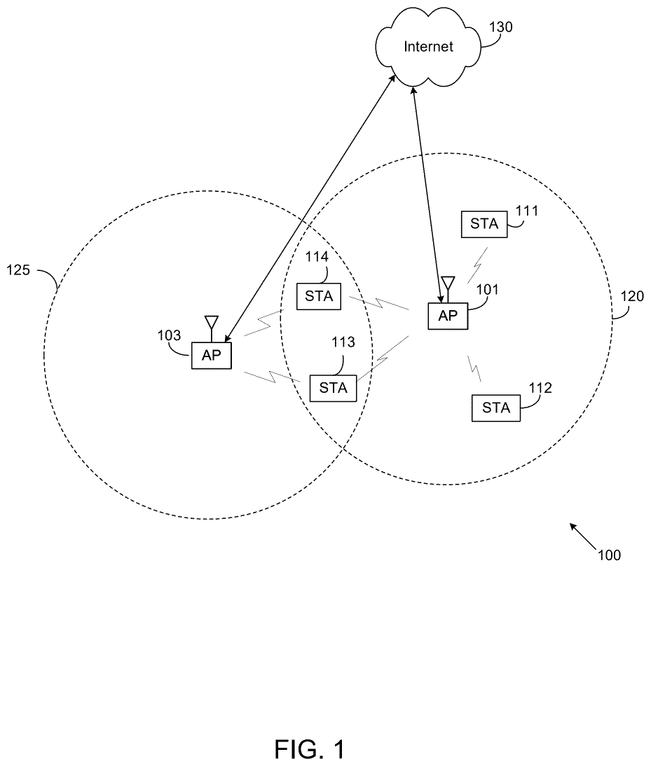

FIGS. 1 through 24, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as multi-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1.

For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

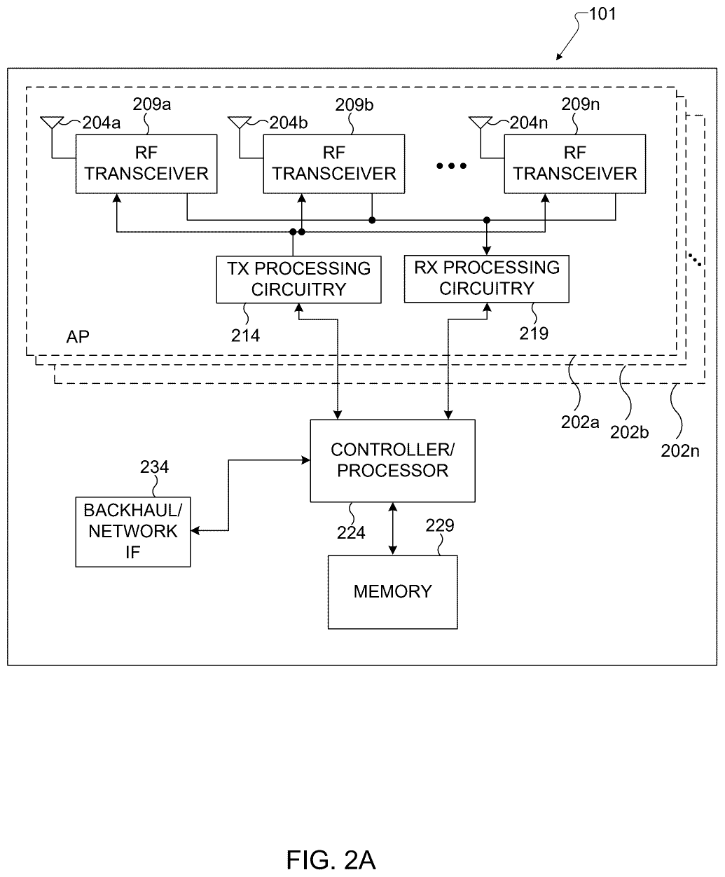

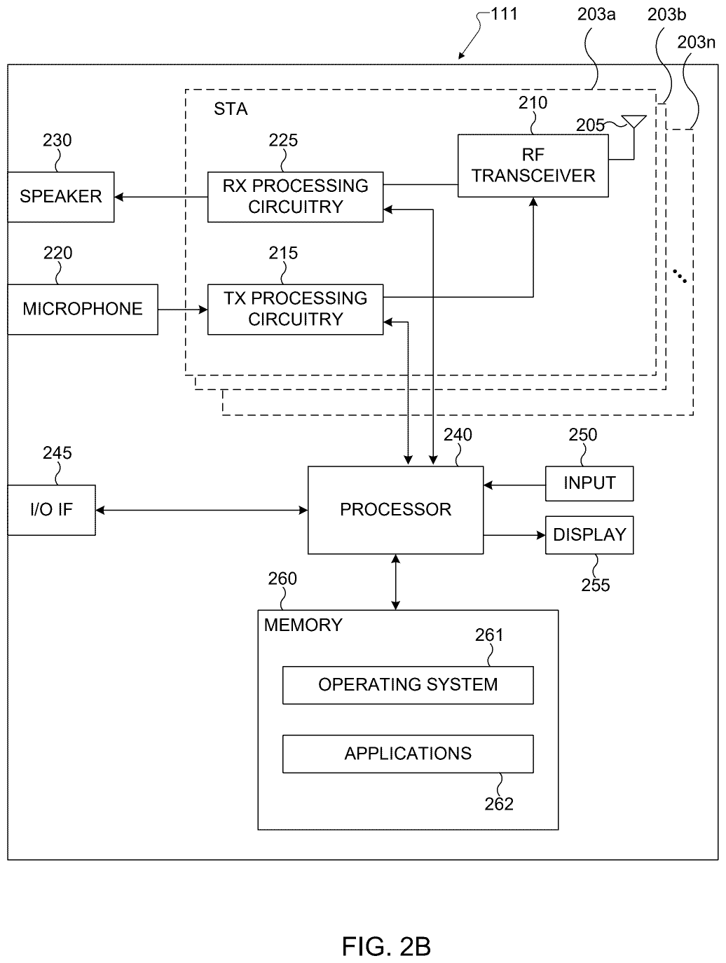

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHZ, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

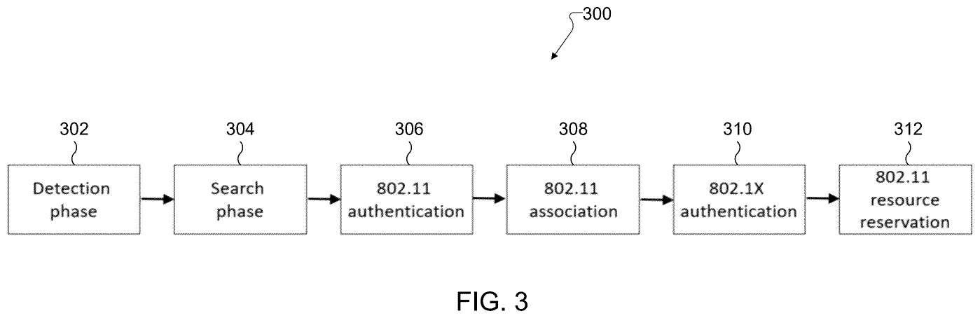

As users move around, the signal strength of a STA to its connected AP can vary. If user movement causes a significant decrease in the signal strength, a handover may be beneficial. During the process of handover, the STA switches from its current associated AP to a new AP. For devices that lack mobility support, handover may use the procedure shown in FIG. 3.

FIG. 3 illustrates an example method for handover 300 according to embodiments of the present disclosure. An embodiment of the method illustrated in FIG. 3 is for illustration only. One or more of the components illustrated in FIG. 3 may be implemented in specialized circuitry configured to perform the noted functions or one or more of the components may be implemented by one or more processors executing instructions to perform the noted functions. Other embodiments for handover could be used without departing from the scope of this disclosure.

In the example of FIG. 3. The method for handover 300 begins at step 302, which is a detection phase. During the detection phase, the STA determines that a handover is triggered. The procedure to detect that a handover is triggered is up to vendor implementation. For example, a particular vendor implementation can choose to trigger handover when the signal strength to the currently associated AP drops below a certain threshold.

After the STA determines that a handover is triggered, the method proceeds to a search phase at step 304. During the search phase, the STA searches for new APs to associate with. For example, in some embodiments, the STA performs a scan of different channels to identify APs in the vicinity. The search can be performed passively (e.g., listening to beacons on a particular channel) or actively (e.g., by the use of probe request and response procedure).

After the search phase, the STA performs 802.11 authentication with a new AP at step 306. After the STA is authenticated, the STA performs 802.11 association at step 308.

After association, the STA performs 802.1X authentication at step 310. This phase includes an extensible authentication protocol (EAP) authentication between the STA and an authentication, authorization, and accounting (AAA) server with the assistance of the AP.

After 802.1X authentication, the STA sets up various resources at the new AP at step 312. For example, the STA can perform QoS reservation, BA setup, etc. with the newly associated AP.

Although FIG. 3 illustrates one example method for handover 300, various changes may be made to FIG. 3. For example, while shown as a series of steps, various steps in FIG. 3 could overlap, occur in parallel, occur in a different order, occur any number of times, be omitted, or replaced by other steps.

Typically, during a handover, there can be a service disruption in the connection as the setup procedure operates in a break-before-make manner. This can cause an impact on user experience, especially with multimedia services, which can suffer from session disruptions due to the high delay encountered during a handover procedure.

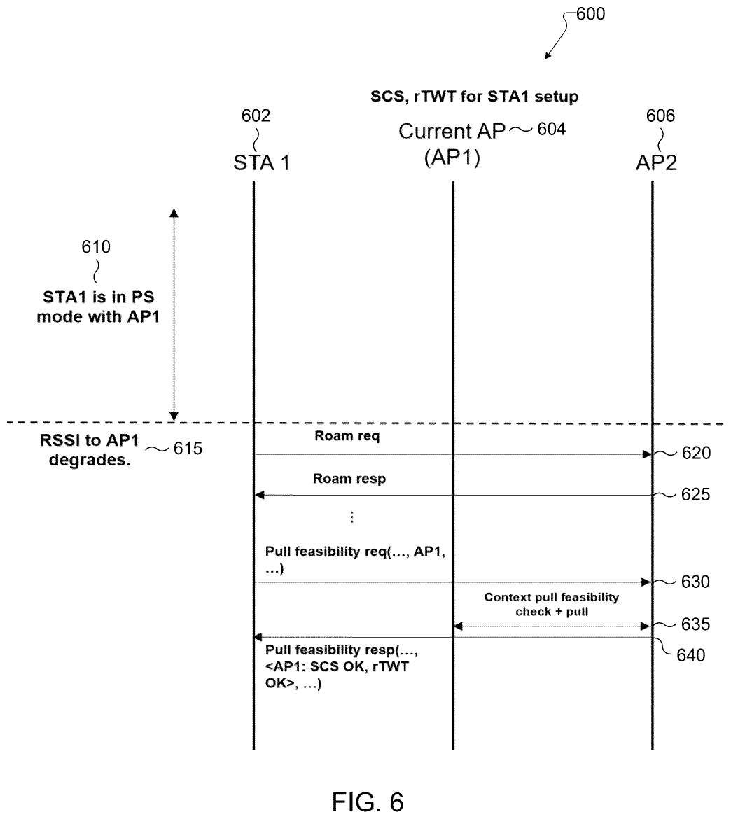

In order to reduce the handover delay, a number of procedures have been introduced, such as:
fast transition roaming which eliminates the need for the authentication step (step 306 in FIG. 3) during the handover;
assisted roaming which reduces the search phase (step 304 in FIG. 3) by allowing the STA to request the AP to send channel information of candidate neighbor APs;
network assisted roaming to assist the search phase;
fast basic service set (BSS) transition procedure, which helps to reduce the delays encountered due to 802.11 resource reservation (step 312 in FIG. 6).

However, in the procedures above, the STA may still need to perform the association and authentication phases which can take 10s of ms.

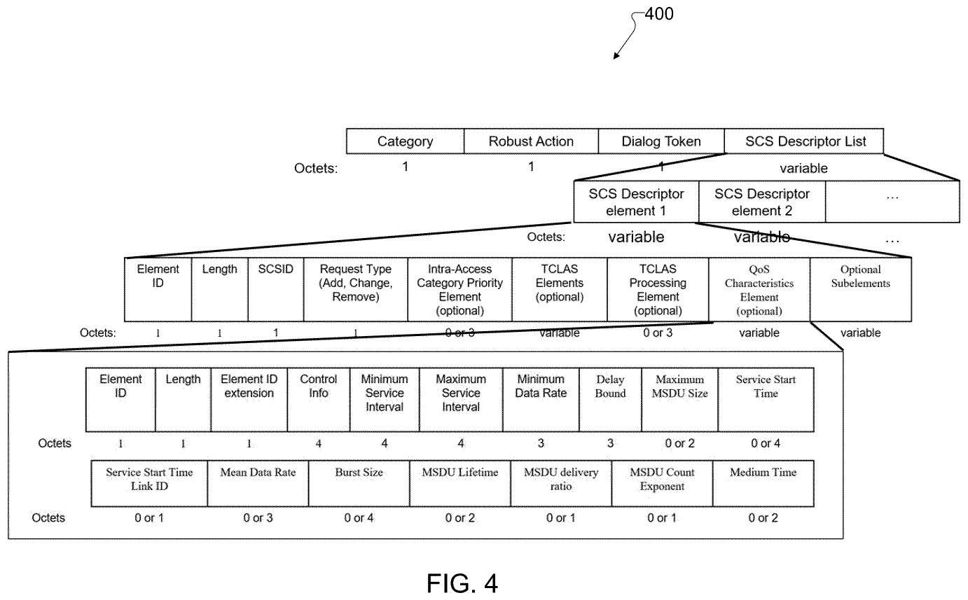

FIG. 4 illustrates an example stream classification service (SCS) request frame format 400 according to embodiments of the present disclosure. The embodiment of an SCS request frame of FIG. 4 is for illustration only. Different embodiments of an SCS request frame format could be used without departing from the scope of this disclosure.

In the example of FIG. 4, the SCS request frame includes the following elements:
1. Intra-access category priority element: The intra-access category priority element can provide the information from a non-AP STA to an AP on the relative priorities of streams within an AC.
2. Traffic classification (TCLAS element): The TCLAS element contains a set of parameters necessary to identify various kinds of PDU or incoming MSDU (from a higher layer in all STAs or from the DS in an AP) that belong to a particular TS. The Frame Classifier field comprises the following subfields: Classifier Type, Classifier Mask, and Classifier Parameters.
3. TCLAS processing element: The TCLAS processing element is present when there are multiple TCLAS elements present in the descriptor. The TCLAS processing element provides information on how to handle the multiple TCLAS elements.
4. QoS characteristics element: The QoS characteristics element describes the QoS expectations of a flow.
5. Optional sub-elements

Although FIG. 4 illustrates one example SCS request frame format 400, various changes may be made to FIG. 4. For example, various changes to fields could be made, etc. according to particular needs.

A STA may not be communicating with its current AP (e.g., “AP1”) for many reasons when the STAs roam point is triggered. For example, the STA may be in power save (PS) mode and may be performing some other operations and when it comes out of PS its signal strength to its current AP may have degraded and a roam point may be triggered causing the STA to associate with another AP (e.g., “AP2”).

When the STA associates with AP2, the STA may need to setup its context with AP2 again. This can take some time as multiple negotiations for each feature are completed with AP2. Further, for some of the features, AP2 may not accept the same parameters that the STA had negotiated with AP1.

It can be beneficial if STA1 can check which of the features setup with AP1 can be directly transferred to AP2. This can enable the STA to decide if the STA can stay with AP2 or move to another (e.g., “AP3”). Also, it can be beneficial to check if for some of the features, AP2 can have some suggested parameters to STA1 as alternatives to what was being used with AP1. A procedure by which a context pull feasibility check can be performed is desirable.

Various embodiments of the present disclosure provide mechanisms for handling a context transfer feasibility pull.

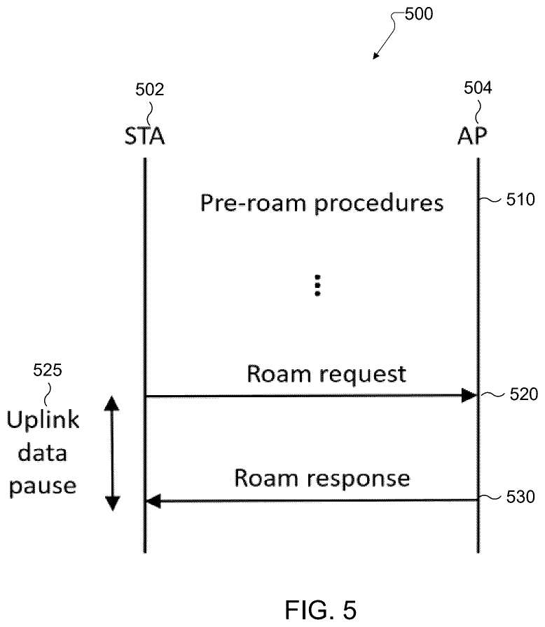

When a STA sends a roam request to its current AP, the STA can receive a roam response. A roam request may also be referred to as an execution request, and a roam response may also be referred to as an execution response. During the time the STA awaits the roam response, there can be a pause on the uplink (e.g., if distribution system [DS] remapping has already been notified, the AP may not forward any user data in the received reorder buffer to the next MAC process) as shown in FIG. 5.

FIG. 5 illustrates an example of an uplink data pause 500 according to embodiments of the present disclosure. The embodiment of an uplink data pause of FIG. 5 is for illustration only. Different embodiments of an uplink data pause could be used without departing from the scope of this disclosure.

In the example of FIG. 5, AP 504 is a current AP for STA 502 at step 510, where STA 502 and AP 504 perform pre-roam procedures. At step 520, STA 502 transmits a roam request to AP 504, resulting in an uplink data pause 525 for STA 502 until STA 502 receives a roam response from AP 504 at step 530.

Although FIG. 5 illustrates one example of an uplink data pause 500, various changes may be made to FIG. 5. For example, various changes to pre-roam procedures could be made, etc. according to particular needs.

During an uplink data pause where the STA is awaiting a roam response from the STA's current AP, the current AP can transmit any downlink (DL) frames buffered at the AP. This can create an issue for the STA, which can be stuck with the current AP to receive DL frames while having the STA's uplink transmission suspended. A procedure that can enable the STA to address this situation is desirable.

Various embodiments of the present disclosure provide mechanisms for handling a downlink data transmission skip indication.

When a STA sets up a stream classification service (SCS) with an AP, the STA can indicate parameters such as delay bound, MSDU lifetime, MSDU delivery ratio etc., which can indicate to the AP the scheduling requirement or request for packets that belong to the stream. However, the AP may not be able to assess if the AP is able to meet these requirements or requests due to a number of reasons. For instance, the traffic may be aperiodic/non-deterministic/event based, and the AP may not know the time the packets arrive at the STA side. Further, the AP may not know the delays that the packets face at the STA side. This can result in a number of inefficiencies in scheduling. For instance, there may be some delays that the packets may face as the triggers of the AP are not aligned with the packets' arrival time. Procedures by which the AP can gain an understanding of how to adjust its scheduling procedure in real time could be helpful for the AP.

Various embodiments of the present disclosure provide mechanisms for handling quality of service (QoS) monitoring at the AP side.

As noted above, various embodiments of the present disclosure provide mechanisms for handling a context transfer feasibility pull.

In some embodiments, a STA can transmit a context transfer pull feasibility request message to a new AP. A context transfer pull feasibility request message may also be referred to as a preparation request message. In embodiments, such as these, the new AP can process the request and transmit a response. The response may be referred to as a context transfer feasibility response message. The response may also be referred to as a preparation response message. In some embodiments, the response can indicate to the STA which contexts can be pulled from the STA's prior AP to the new AP. In some embodiments, the context pull feasibility request message can also result in a context transfer from the previous AP to the new AP.

FIG. 6 illustrates an example call flow of a context pull feasibility check performed after roaming 600 according to embodiments of the present disclosure. An embodiment of the call flow illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a call flow of a context pull feasibility check performed after roaming could be used without departing from the scope of this disclosure.

In the example of FIG. 6, the call flow begins at step 610. At step 610, a STA (“STA1”) 602 is in a power saving (PS) mode with a first AP (“AP1”) 604. At step 615, a received signal strength indicator (RSSI) to AP 604 for STA 602 degrades, and STA 602 transmits a roam request to a second AP (“AP2”) 606 at step 620. In response, at step 625, AP 606 transmits a roam response to STA 602.

At step 630, STA 602 transmits a context transfer pull feasibility request with respect to AP 604 to AP 606. In response, at step 635, AP 606 performs a context pull feasibility check and a context pull with AP 604. At step 640, AP 606 sends an affirmative context transfer pull feasibility response to STA 602.

Although FIG. 6 illustrates one example call flow of a context pull feasibility check performed after roaming 600, various changes may be made to FIG. 6. For example, while shown as a series of steps, various steps in FIG. 6 could overlap, occur in parallel, occur in a different order, occur any number of times, be omitted, or replaced by other steps.

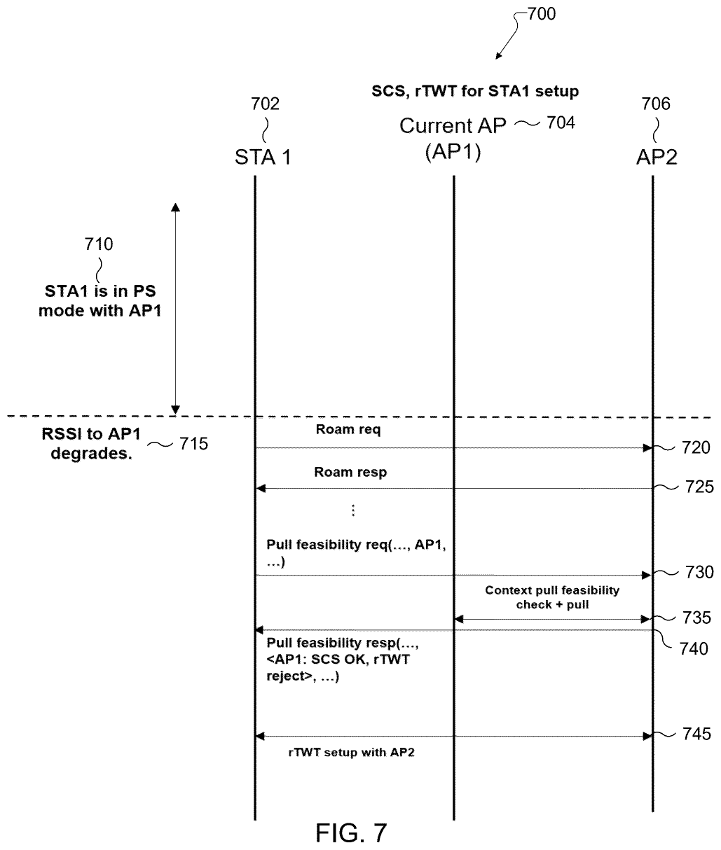

FIG. 7 illustrates an example call flow of a context pull feasibility check performed after roaming with a re-setup for one or more features 700 according to embodiments of the present disclosure. An embodiment of the call flow illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a call flow of a context pull feasibility check performed after roaming with a re-setup for one or more features could be used without departing from the scope of this disclosure.

In the example of FIG. 7, the call flow begins at step 710. At step 710, a STA (“STA1”) 702 is in a PS mode with a first AP (“AP1”) 704. At step 715, an RSSI to AP 704 for STA 702 degrades, and STA 702 transmits a roam request to a second AP (“AP2”) 706 at step 720. In response, at step 725, AP 706 transmits a roam response to STA 702.

At step 730, STA 702 transmits a context transfer pull feasibility request with respect to AP 704 to AP 706. In response, at step 735, AP 706 performs a context pull feasibility check and pull with AP 704. At step 740, AP 706 sends a partially affirmative context transfer pull feasibility response to STA 702, indicating that context could not be transferred for all of the features (i.e., “rTWT”).

At step 745, STA 702 and AP 706 perform a re-setup for features of which context could not be transferred from AP 704 (i.e., “rTWT”).

Although FIG. 7 illustrates one example call flow of a context pull feasibility check performed after roaming with a re-setup for one or more features 700, various changes may be made to FIG. 7. For example, while shown as a series of steps, various steps in FIG. 7 could overlap, occur in parallel, occur in a different order, occur any number of times, be omitted, or replaced by other steps.

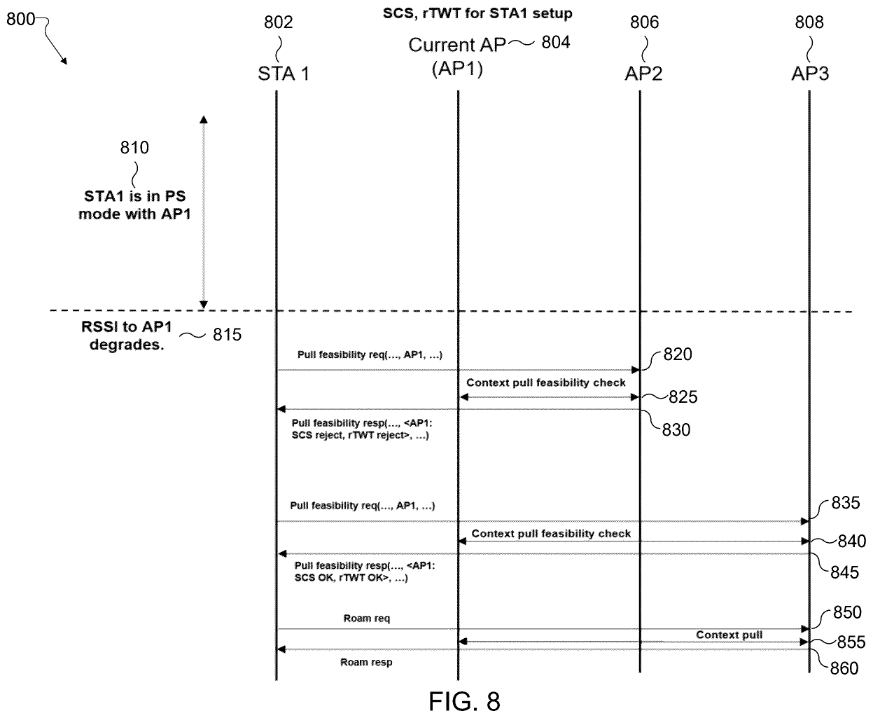

FIG. 8 illustrates an example call flow of a context pull feasibility check performed prior to roaming 800 according to embodiments of the present disclosure. An embodiment of the call flow illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a call flow of a context pull feasibility check performed prior to roaming could be used without departing from the scope of this disclosure.

In the example of FIG. 8, the call flow begins at step 810. At step 810, a STA (“STA1”) 802 is in a power saving (PS) mode with a first AP (“AP1”) 804. At step 815, a received RSSI to AP 804 for STA 802 degrades, and STA 802 transmits a context transfer pull feasibility request with respect to AP 804 to a second AP (“AP2”) 806 at step 820. In response, at step 825, AP 806 performs a context pull feasibility check with AP 804.

At step 830, AP 806 sends a negative context transfer pull feasibility response to STA 802. In response, STA 802 transmits a context transfer pull feasibility request with respect to AP 804 to a third AP (“AP3”) 808 at step 835. In response, at step 840, AP 808 performs a context pull feasibility check with AP 804.

At step 845, AP 808 sends an affirmative context transfer pull feasibility response to STA 802. In response, STA 802 transmits a roam request to AP 808 at step 850. At step 855, AP 808 performs a context pull with AP 804, and transmits a roam response to STA 802 at step 860.

Although FIG. 8 illustrates one example call flow of a context pull feasibility check performed prior to roaming 800, various changes may be made to FIG. 8. For example, while shown as a series of steps, various steps in FIG. 8 could overlap, occur in parallel, occur in a different order, occur any number of times, be omitted, or replaced by other steps.

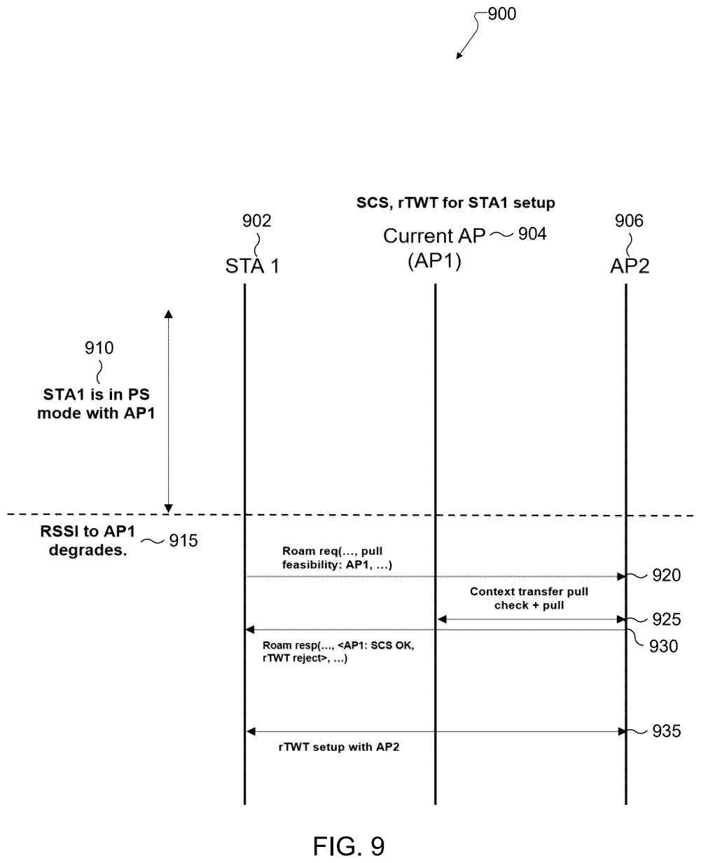

FIG. 9 illustrates an example call flow of a context pull feasibility check performed as part of the roaming procedure 900 according to embodiments of the present disclosure. An embodiment of the call flow illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a call flow of a context pull feasibility check performed as part of the roaming procedure could be used without departing from the scope of this disclosure.

In the example of FIG. 9, the call flow begins at step 910. At step 910, a STA (“STA1”) 902 is in a PS mode with a first AP (“AP1”) 904. At step 915, an RSSI to AP 904 for STA 902 degrades, and STA 902 transmits a roam request to a second AP (“AP2”) 906 at step 920. The roam request includes a context transfer pull feasibility request with respect to AP 904.

In response, at step 925, AP 906 performs a context pull feasibility check and context pull with AP 904, and transmits a roam response to STA 902 at step 930. The roam response includes a partially affirmative context transfer pull feasibility response indicating that context could not be transferred for all of the features (i.e., “rTWT”).

At step 935, STA 902 and AP 906 perform a re-setup for features of which context could not be transferred from AP 904 (i.e., “rTWT”).

Although FIG. 9 illustrates one example call flow of a context pull feasibility check performed as part of the roaming procedure, various changes may be made to FIG. 9. For example, while shown as a series of steps, various steps in FIG. 9 could overlap, occur in parallel, occur in a different order, occur any number of times, be omitted, or replaced by other steps.

In some embodiments, an AP that supports a context transfer feasibility pull may advertise this capability in one or more messages transmitted by the AP. For example, the context transfer feasibility pull capability may be advertised in one or more of a beacon, a probe response, etc. In some embodiments, the advertisement may inform a STA that a context transfer feasibility pull may be initiated with the advertising AP.

An AP that can support a context transfer feasibility pull can advertise its capability in one or more messages that it can transmit (e.g., beacons or probe responses). This advertisement can inform the STA about the possibility of initiation of context transfer feasibility pull procedure with the new AP.

In some embodiments, the signaling for a context transfer pull can be performed via the multi-link reconfiguration request framework. For example, the multi-link reconfiguration request framework can be used when the new AP MLD and the previous AP MLD are a part of the same seamless roaming mobility domain.

In some embodiments, a link reconfiguration request frame may have a format similar to as shown in Table 1.

TABLE 1
Example modified link reconfiguration
request frame action field format.

| Order | Meaning |
|---|---|
| 1 | Category |
| 2 | Protected UHR/EHT Action |
| 3 | Dialog token |
| 4 | Context pull indication |
| 5 | AP MLD identifier |
| 6 | Context to be pulled |
| 8 | Reconfiguration Multi-link element (optional) |
| 9 | OCI element |

In some embodiments, a link reconfiguration request frame may have a format similar to as shown in Table 1, with a different order. In some embodiments, a link reconfiguration request frame may have a format similar to as shown in Table 1, with additional information items in the action frame not shown in Table 1.

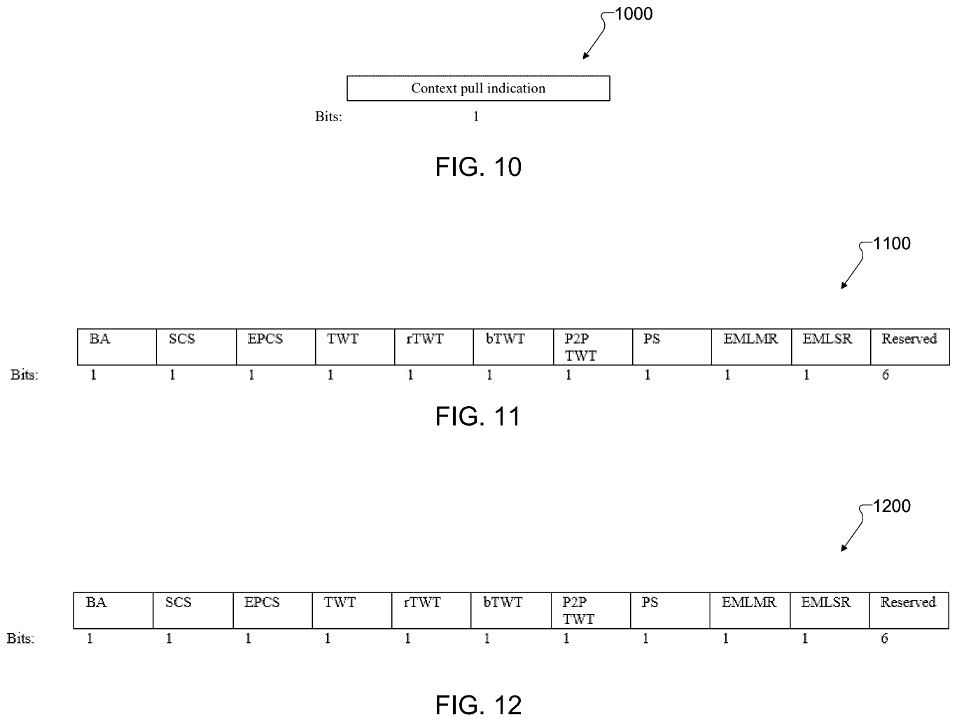

In some embodiments, an indication bit, such as shown in FIG. 10, can indicate if a context pull can be performed. In some embodiments, the indication bit can be an independent bit in a link reconfiguration request frame.

FIG. 10 illustrates an example independent bit based indication 1000 according to embodiments of the present disclosure. The embodiment of an independent bit based indication of FIG. 10 is for illustration only. Different embodiments of an independent bit based indication could be used without departing from the scope of this disclosure.

In the example of FIG. 10, the indication bit is context pull indication. In some embodiments, if the bit value is 1, then the receiving AP MLD can perform a context pull from the AP MLD identified by the AP MLD identifier. The reconfiguration multi-link element can be absent in the request frame and the context can be pulled for MLD level contexts.

In some embodiments, the context pull can also be per link and the links can be indicated in the reconfiguration multi-link element.

Although FIG. 10 illustrates one example independent bit based indication 1000, various changes may be made to FIG. 10. For example, various changes to the type of indication could be made, etc. according to particular needs.

In some embodiments, a bit/field may take multiple values to make the indication of context pull intent. In embodiments such as these, the interpretation of this bit can be dependent on a few conditions. For instance, if the bit is set to 0 and no reconfiguration multi-link element is present in the request frame, then the receiving AP MLD can perform a context pull from the AP MLD indicated in the AP MLD identifier field in the link reconfiguration request frame. The non-AP MLD transmitting this frame can be a non-AP MLD associated with the receiving AP MLD. In some embodiments, behavior can be summarized as in Table 2.

TABLE 2
Example of multi-link reconfiguration framework
usage using a single bit indication

| Bit | Reconfiguration | |
|---|---|---|
| value | ML element | Behavior |
| 0 | Absent | Receiving AP MLD: |
| | | Can perform a near static context pull from |
| | | the indicated AP MLD in the request frame. |
| | | The indicated AP MLD can be a part of the |
| | | same seamless roaming domain as the |
| | | receiving AP MLD. |
| | | Can generate and send a link reconfiguration |
| | | response frame to the non-AP MLD |
| | | indicating a success or failure. |
| | | Previous AP MLD: |
| | | The previous AP MLD can send the context |
| | | corresponding to the non-AP MLD to the |
| | | above receiving AP MLD. |
| | | The previous AP MLD can remove the |
| | | context corresponding to the non-AP MLD. |
| | | Non-AP MLD: |
| | | Can wait for the above receiving AP MLD to |
| | | send a response. |
| | | Can re-setup features/context/setup that were |
| | | not pulled from the previous AP MLD. |

In some embodiments, a link reconfiguration request frame may include an AP MLD identifier. In embodiments as these, the AP MLD identifier (e.g., AP MLD MAC address, AP MLD ID, etc.) may be for the previous AP MLD that the non-AP MLD was associated with.

In some embodiments, a link reconfiguration request frame may include a context to be pulled. In embodiments such as these, the context to be pulled can be an indication of the context that can be pulled from the previous AP MLD. For example, in some embodiments, the context to be pulled can be an indication made in the form of a bit for each feature/setup/context that is established with the previous AP MLD, similar as shown in FIG. 11.

FIG. 11 illustrates an example bit based indication for pulled context 1100 according to embodiments of the present disclosure. The embodiment of bit based indication for pulled context of FIG. 11 is for illustration only. Different embodiments of a bit based indication for pulled context could be used without departing from the scope of this disclosure.

In the example of FIG. 11, each bit corresponds to a feature/context/setup. In some embodiments, the bit value corresponding to a feature/context/setup can take a value of 1 if the context was pulled successfully and 0 if the context was not pulled successfully.

Although FIG. 11 illustrates one example bit based indication for pulled context 1100, various changes may be made to FIG. 11. For example, various changes to the features/setup could be made, etc. according to particular needs.

In some embodiments, a link reconfiguration response frame may have a similar format as shown in Table 3.

TABLE 3
Example link reconfiguration response frame action field format

| Order | Meaning |
|---|---|
| 1 | Category |
| 2 | Protected EHT/UHR Action |
| 3 | Dialog Token |
| 4 | Pulled context indication |
| 5 | Operation parameters |

In some embodiments, a link reconfiguration response frame may have a format similar as shown in Table 3, with a different order. In some embodiments, a link reconfiguration request frame may have a format similar to as shown in Table 3, with additional information items in the action frame not shown in Table 3.

In some embodiments, a link reconfiguration request frame may include a pulled context. In embodiments such as these, the pulled context can be an indication of the features for which context that can be pulled from the previous AP MLD. For example, in some embodiments, the context to be pulled can be similar as shown in FIG. 12.

FIG. 12 illustrates an example frame format for pulled context indication 1200 according to embodiments of the present disclosure. The embodiment of a frame format for pulled context indication of FIG. 12 is for illustration only. Different embodiments of a frame format for pulled context indication could be used without departing from the scope of this disclosure.

In the example of FIG. 12, each bit corresponds to a feature/context/setup indication. In some embodiments, the bit value corresponding to a feature/context/setup indication can take a value of 1 if the context was pulled successfully and 0 if the context was not pulled successfully. In some embodiments, the non-AP MLD can re-setup the features/setup for the ones that are not successfully pulled with its new AP MLD if necessary.

Although FIG. 12 illustrates one example frame format for pulled context indication 1200, various changes may be made to FIG. 12. For example, various changes to the features/setup could be made, etc. according to particular needs.

In some embodiments, for the context that was pulled there can be an indication of the operation parameters at the new AP MLD. In embodiments such as these, the operation parameters may be similar as shown in Table 4.

TABLE 4
Example operation parameters field.

| Information | |
|---|---|
| item | Example |
| SCS | One or more SCS descriptor elements that contain the information |
| parameters | corresponding to the operation of SCS at the above receiving AP MLD. |
| | Optional parameters in the SCS descriptor element that are not necessary to |
| | describe the operation parameters of SCS transferred to the above receiving |
| | AP MLD may not be present. E.g., An SCS descriptor element that can |
| | contain a QoS characteristic element that can indicate a service start time |
| | and service start time link ID corresponding to an SCSID indicated in the |
| | SCS descriptor element. |
| EPCS | emergency preparedness communication services (EPCS) priority access |
| parameters | multi-link element carrying an enhanced distributed channel access (EDCA) |
| | and a multi-user (MU) EDCA parameter set element. Alternatively, the |
| | elements can be present separately with a separate indication that they |
| | correspond to EPCS operation and not to normal EDCA and MU EDCA |
| | operation. These can be the parameters to use at the new AP MLD. |

In some embodiments the field of Table 4 can contain one or more information items for each of the features grouped together in a single field/element/individual elements.

In some embodiments, when a non-AP MLD receives operation parameters from an AP MLD, the non-AP MLD can start to use the received operation parameters for the non-AP MLD's current operation as soon as possible in the non-AP MLD's implementation.

In some embodiments, a non-AP MLD can stop sending data frames to its current AP MLD upon reception of a preparation response frame from a target AP MLD with at least one of the requested links accepted, as a response to a preparation request frame sent to the target AP MLD over-the-air directly.

In some embodiments, if a preparation request was sent to a target AP MLD over-the-air directly, the non-AP MLD can initiate a transition execution procedure by sending an execution request frame requesting BSS transition to the same target AP MLD within a timeout value.

In some embodiments, if the target AP MLD receives an execution request beyond the timeout value or the target AP MLD has not been prepared for BSS transition for the non-AP MLD, the target AP MLD can send an execution response frame to the non-AP MLD with the status code field set to indicate a rejected execution request due to timeout criteria or due to lack of preparation.

In some embodiments, a current AP MLD can transmit a BSS transition management (BTM) request to the non-AP MLD providing a list of AP MLDs that have been prepared for the non-AP MLD to roam to (i.e., to perform a preparation or execution direction with the AP MLD). In embodiments such as these, the non-AP MLD can then perform a roam preparation and/or execution through one of those AP MLDs.

In some embodiments, the current AP MLD can provide a list of links prepared and the context transferred to the prepared target AP MLDs. In some embodiments, this can indicate to the non-AP MLD the links to use and the context that has been transferred to the prepared target AP MLDs.

In some embodiments, the non-AP MLD can perform a preparation through the current AP MLD and the execution through the target AP MLD.

In some embodiments, the non-AP MLD can receive a recommendation from the current AP MLD through the BTM request and then perform an execution with the target AP MLD.

As noted above, various embodiments of the present disclosure provide mechanisms for handling a downlink data transmission skip indication.

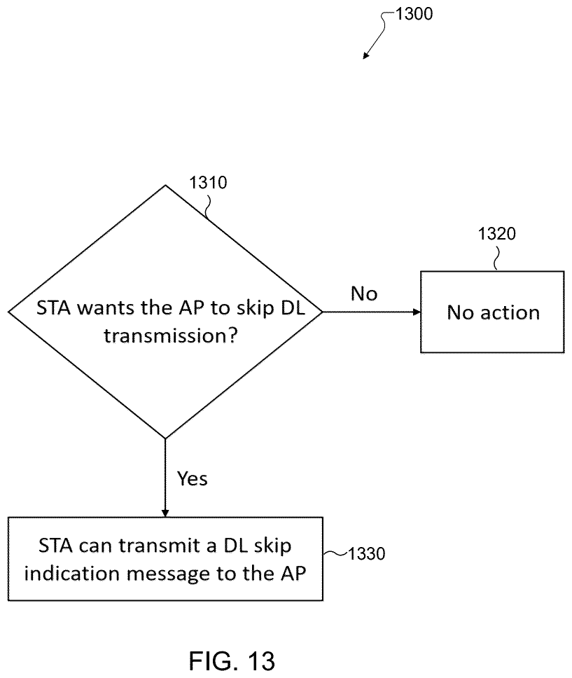

In some embodiments, a STA may provide a downlink data transmission skip indication. For example, the STA may perform the procedure of FIG. 13.

FIG. 13 illustrates an example downlink skip indication procedure 1300 according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a downlink skip indication procedure could be used without departing from the scope of this disclosure.

In the example of FIG. 13, procedure 1300 begins at step 1310. At step 1310, a STA (such as STA 502 of FIG. 5) determines whether the STA wants to skip DL transmission. For example, the STA may be receiving a large amount of DL transmissions from the current AP (such as AP 504 of FIG. 5) after transmitting a roam request to the AP. If the STA does not wish to skip the DL transmission, it takes no action at step 1320. Otherwise, if the STA wishes to skip the DL transmission, the STA can transmit a DL skip indication message to the AP at step 1330.

Although FIG. 13 illustrates one example downlink skip indication procedure 1300, various changes may be made to FIG. 13. For example, while shown as a series of steps, various steps in FIG. 13 could overlap, occur in parallel, occur in a different order, occur any number of times, be omitted, or replaced by other steps.

In some embodiments, a downlink data transmission skip indication message can contain at least one or more of the information items as indicated in Table 5.

TABLE 5
Information items that can be present in a downlink data transmission skip indication

| Information | |
|---|---|
| item | Description |
| Data | One or more information items that can make an indication to the current |
| transmission | AP that the STA can want the AP to skip the downlink data transmission |
| skip | during the roam phase/uplink pause phase. For example, the indication can |
| indication | be a bit that can take a predetermined value (e.g., 1) to make the indication |
| | and to another predetermined value (e.g., 0) to indicate otherwise. |
| Data handling | One or more information items that can indicate to the current AP how to |
| action | handle the data during the downlink data transmission skip. Example |
| | actions can be to drop all, drop selectively (specific TIDs, AC, SCS IDs, |
| | etc.), drop some and forward some to the target AP (with an indication of |
| | which to drop and which to forward where the indication can be given in |
| | terms of frames belonging to specific TIDs, ACs, SCS IDs, etc.), forward |
| | all to the target AP, etc. |
| Start time | One or more information items that can indicate the start time after which |
| indication | the data transmission skip action can be taken. For example, a start time |
| | indicated in terms of one or more bits of the TSF timer, start time indicated |
| | as a duration of time after the transmission of the roam request, etc. |

In some embodiments, the information items in Table 1 can be carried in a single frame. In some embodiments, the information items in Table 1 can be split across multiple frames.

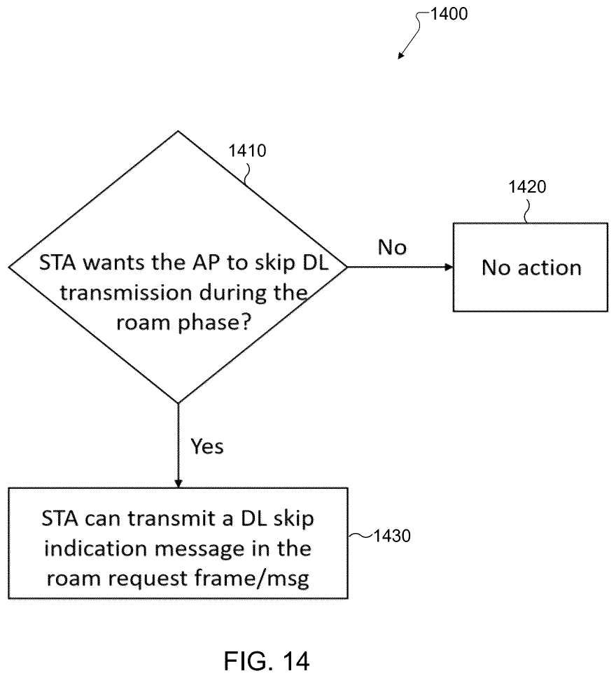

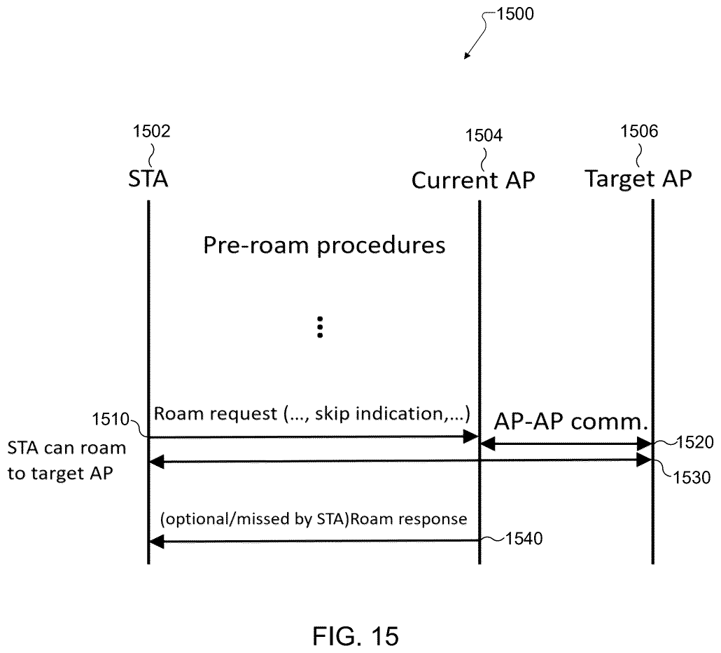

In some embodiments, the STA can transmit a downlink skip indication during the roam phase. In embodiments such as these, the STA can transmit this message as a part of the roam request message, similar as shown in FIG. 14 and FIG. 15.

FIG. 14 illustrates an example roam phase indication procedure 1400 according to embodiments of the present disclosure. An embodiment of the procedure illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a roam phase indication procedure could be used without departing from the scope of this disclosure.

In the example of FIG. 14, procedure 1400 begins at step 1410. At step 1410, a STA (such as STA 1502 of FIG. 15) determines whether the STA wants to skip DL transmission during the roam phase. If the STA does not wish to skip the DL transmission, it takes no action at step 1420. Otherwise, if the STA wishes to skip the DL transmission, the STA can transmit a DL skip indication message in the roam request frame/msg to the current AP (such as AP 1504 of FIG. 15) at step 1430.

Although FIG. 14 illustrates one example roam phase indication procedure 1400, various changes may be made to FIG. 14. For example, while shown as a series of steps, various steps in FIG. 14 could overlap, occur in parallel, occur in a different order, occur any number of times, be omitted, or replaced by other steps.

FIG. 15 illustrates an example roam phase skip indication call flow 1500 according to embodiments of the present disclosure. An embodiment of the call flow illustrated in FIG. 1500 is for illustration only. One or more of the components illustrated in FIG. 1500 may be implemented in specialized circuitry configured to perform the noted functions or one or more of the components may be implemented by one or more processors executing instructions to perform the noted functions. Other embodiments of a roam phase skip indication call flow could be used without departing from the scope of this disclosure.

In the example of FIG. 15, the call flow begins at step 1510. At step 1510, a STA 1502 transmits a roam request to a current AP 1504. The roam request includes a skip indication. The roam request triggers AP-AP communication between AP 1504 and a target AP 1506 at step 1520. At step 1530, STA 1502 roams to AP 1506. At step 1540, STA 1502 receives a roam response from AP 1504.

Although FIG. 15 illustrates one example roam phase skip indication call flow 1500, various changes may be made to FIG. 15. For example, while shown as a series of steps, various steps in FIG. 15 could overlap, occur in parallel, occur in a different order, occur any number of times, be omitted, or replaced by other steps.

In some embodiments, after a STA transmits a skip indication, the STA can roam to the target AP and start its data transmission/reception with the target AP, similar as shown in FIG. 15 at step 1530.

In some embodiments, a current AP receives a skip indication from a STA, the current AP can perform necessary communication with the target AP to prepare it for the STA's roam, similar as shown in FIG. 15 at step 1520. In some embodiments, the current AP can also skip the roam response or not retransmit it if no acknowledgement is received from the STA.

In some embodiments, the current AP can also handle the incoming downlink data for the STA and take appropriate actions (e.g., dropping frames, forwarding frames to the target AP, etc.). In embodiments such as these, the current AP can also take these actions based on the STA's preferences.

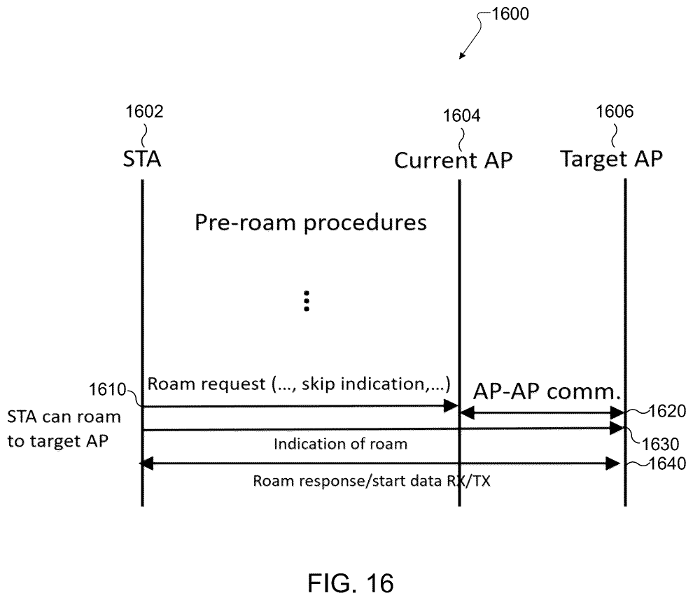

In some embodiments, the STA can switch channels and transmit a roam indication message to the target AP to inform the target AP about its roam to the target AP. In embodiments such as these, the target AP can transmit a roam response message to the STA or alternatively start the data transmission RX/TX with the STA, similar as shown in FIG. 16.

FIG. 16 illustrates another example roam phase indication call flow 1600 according to embodiments of the present disclosure. An embodiment of the call flow illustrated in FIG. 1600 is for illustration only. One or more of the components illustrated in FIG. 1600 may be implemented in specialized circuitry configured to perform the noted functions or one or more of the components may be implemented by one or more processors executing instructions to perform the noted functions. Other embodiments of a roam phase indication call flow could be used without departing from the scope of this disclosure.

In the example of FIG. 16, the call flow begins at step 1610. At step 1610, a STA 1602 transmits a roam request to a current AP 1604. The roam request includes a skip indication. The roam request triggers AP-AP communication between AP 1604 and a target AP 1606 at step 1620. At step 1630, STA 1602 transmits an indication of roam to AP 1606. At step 1640, STA 1602 receives a roam response from or alternatively start the data transmission RX/TX from AP 1606.

Although FIG. 16 illustrates one example roam phase indication call flow 1600, various changes may be made to FIG. 16. For example, while shown as a series of steps, various steps in

FIG. 16 could overlap, occur in parallel, occur in a different order, occur any number of times, be omitted, or replaced by other steps.

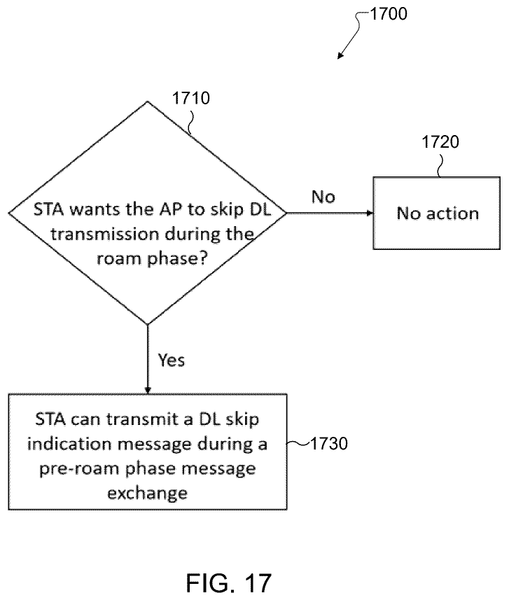

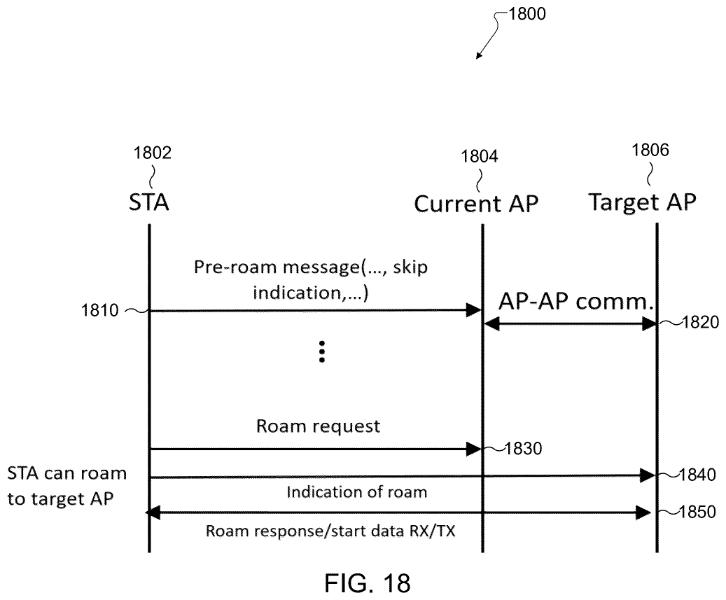

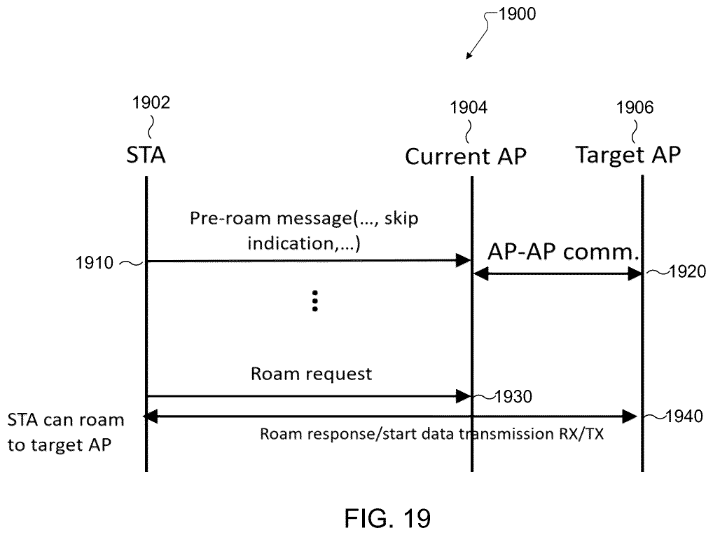

In some embodiments, the STA can transmit a downlink skip indication during a pre-roam phase, similar as shown in FIG. 17, FIG. 18 and FIG. 19. In embodiments such as these, a pre-roam phase can be any message exchange that occurs prior to the transmission of a roam request.

FIG. 17 illustrates an example pre-roam phase indication procedure 1700 according to embodiments of the present disclosure. An embodiment of the procedure illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of a pre-roam phase indication procedure could be used without departing from the scope of this disclosure.

In the example of FIG. 17, procedure 1700 begins at step 1710. At step 1710, a STA (such as STA 1802 of FIG. 18) determines whether the STA wants to skip DL transmission during the roam phase. If the STA does not wish to skip the DL transmission, it takes no action at step 1720. Otherwise, if the STA wishes to skip the DL transmission, the STA can transmit a DL skip indication message during a pre-roam phase message exchange with the current AP (such as AP 1804 of FIG. 18) at step 1730.

Although FIG. 17 illustrates one example pre-roam phase indication procedure 1700, various changes may be made to FIG. 17. For example, while shown as a series of steps, various steps in FIG. 17 could overlap, occur in parallel, occur in a different order, occur any number of times, be omitted, or replaced by other steps.

FIG. 18 illustrates an example pre-roam phase skip indication call flow 1800 according to embodiments of the present disclosure. An embodiment of the call flow illustrated in FIG. 1800 is for illustration only. One or more of the components illustrated in FIG. 1800 may be implemented in specialized circuitry configured to perform the noted functions or one or more of the components may be implemented by one or more processors executing instructions to perform the noted functions. Other embodiments of a pre-roam phase skip indication call flow could be used without departing from the scope of this disclosure.

In the example of FIG. 18, the call flow begins at step 1810. At step 1810, a STA 1802 transmits a pre-roam message to a current AP 1804. The pre-roam message includes a skip indication. The pre-roam message triggers AP-AP communication between AP 1804 and a target AP 1806 at step 1820.

At step 1830, STA 1802 transmits a roam request to AP 1804. At step 1840, STA 1802 transmits an indication of roam to AP 1806. At step 1850, STA 1802 receives a roam response from or alternatively start the data transmission RX/TX from AP 1806.

Although FIG. 18 illustrates one example pre-roam phase skip indication call flow 1800, various changes may be made to FIG. 18. For example, while shown as a series of steps, various steps in FIG. 18 could overlap, occur in parallel, occur in a different order, occur any number of times, be omitted, or replaced by other steps.

FIG. 19 illustrates another example pre-roam phase skip indication call flow 1900 according to embodiments of the present disclosure. An embodiment of the call flow illustrated in FIG. 1900 is for illustration only. One or more of the components illustrated in FIG. 1900 may be implemented in specialized circuitry configured to perform the noted functions or one or more of the components may be implemented by one or more processors executing instructions to perform the noted functions. Other embodiments of a pre-roam phase skip indication call flow could be used without departing from the scope of this disclosure.

In the example of FIG. 19, the call flow begins at step 1910. At step 1910, a STA 1902 transmits a pre-roam message to a current AP 1904. The pre-roam message includes a skip indication. The pre-roam message triggers AP-AP communication between AP 1904 and a target AP 1906 at step 1920.

At step 1930, STA 1902 transmits a roam request to AP 1904. At step 1940, STA 1902 receives a roam response from or alternatively start the data transmission RX/TX from AP 1906.

Although FIG. 19 illustrates one example pre-roam phase skip indication call flow 1800, various changes may be made to FIG. 19. For example, while shown as a series of steps, various steps in FIG. 19 could overlap, occur in parallel, occur in a different order, occur any number of times, be omitted, or replaced by other steps.

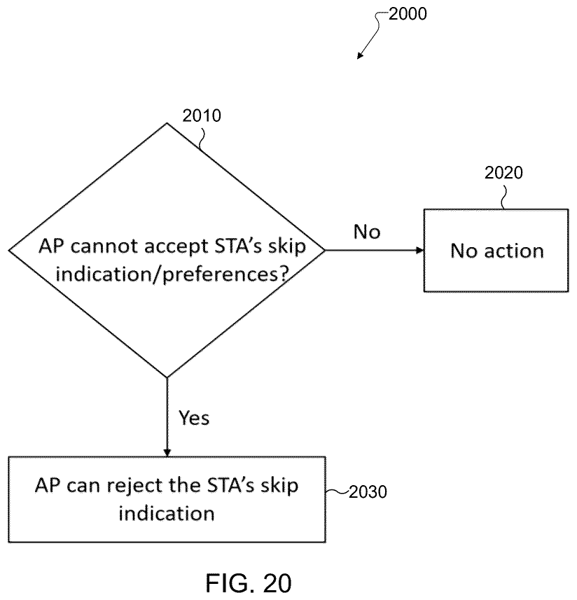

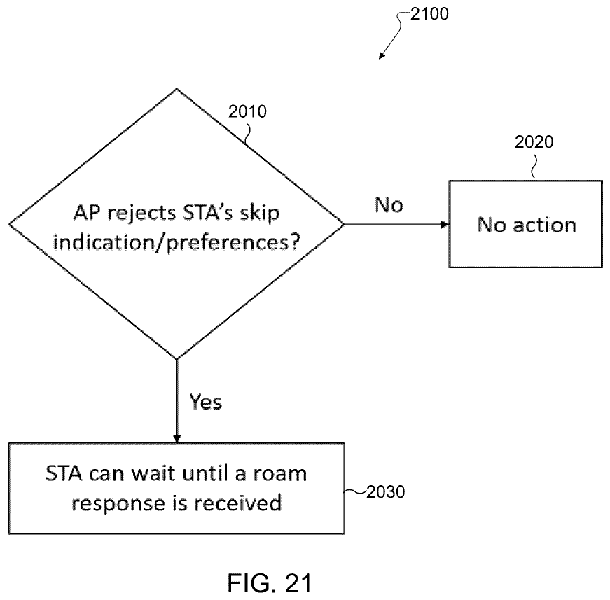

In some embodiments, a downlink skip indication can be a request-response based exchange. In embodiments such as these, the AP can reject the STA's skip indication or one or more configurations/preferences indication in the STA's skip indication, similar as shown in FIG. 20. In such a scenario, the STA can then undergo the uplink pause and wait for a roam response prior to roaming, similar to as shown in FIG. 21.

FIG. 20 illustrates an example request-response based indication procedure 2000 according to embodiments of the present disclosure. An embodiment of the procedure illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a request-response based indication procedure could be used without departing from the scope of this disclosure.

In the example of FIG. 20, procedure 2000 begins at step 2010. At step 2010, an AP (such as AP 504 of FIG. 5) determines whether the AP can accept a STA's (such as STA 502 of FIG. 5) skip indication/preferences. If the AP can accept the STA's skip indication/preferences, the AP takes no action at step 2020. Otherwise, if the AP cannot accept the STA's skip indication/preferences, the AP rejects the STA's skip indication at step 2030.

Although FIG. 20 illustrates one example request-response based indication procedure 2000, various changes may be made to FIG. 20. For example, while shown as a series of steps, various steps in FIG. 20 could overlap, occur in parallel, occur in a different order, occur any number of times, be omitted, or replaced by other steps.

FIG. 21 illustrates a STA response to an AP's rejection procedure 2100 according to embodiments of the present disclosure. An embodiment of the procedure illustrated in FIG. 21 is for illustration only. One or more of the components illustrated in FIG. 21 may be implemented in specialized circuitry configured to perform the noted functions or one or more of the components may be implemented by one or more processors executing instructions to perform the noted functions. Other embodiments of a STA response to an AP's rejection procedure could be used without departing from the scope of this disclosure.

In the example of FIG. 21, procedure 2100 begins at step 2110. At step 2110, a STA (such as STA 502 of FIG. 5) determines an AP (such as AP 504 of FIG. 5) has rejected the STA's skip indication/preferences. If the AP has not rejected the STA's skip indication/preferences, the STA takes no action at step 2120. Otherwise, if the AP has rejected the STA's skip indication/preference, the STA waits until a roam response is received to roam at step 2130.

Although FIG. 21 illustrates one example STA response to an AP's rejection procedure 2100, various changes may be made to FIG. 21. For example, while shown as a series of steps, various steps in FIG. 21 could overlap, occur in parallel, occur in a different order, occur any number of times, be omitted, or replaced by other steps.

In some embodiments, a STA that can support procedures for a skip indication can make an indication in one or more messages that it transmits (e.g., management frames such as probe requests, (re) association requests, etc.) that the STA has a skip indication capability. For example, in some embodiments there can be a field (e.g., a bit) in a message transmitted by the STA which can take a predetermined value (e.g., 1) to make the indication and to another predetermined value (e.g., 0) to indicate otherwise.

In some embodiments, an AP that can support procedures for a skip indication can make an indication in one or more messages that it transmits (e.g., management frames such as beacons, probe response, (re) association responses, etc.) that the AP has a skip indication capability. For example, in some embodiments there can be a field (e.g., a bit) in a message transmitted by the AP that can take a predetermined value (e.g., 1) to make the indication and to another predetermined value (e.g., 0) to indicate otherwise.

In some embodiments, a STA that does not want to suffer from an uplink pause and can tolerate a downlink transmission skip (e.g., STAs with only uplink data, STAs running applications that are more tolerant to packet losses, cases where the STA has low latency traffic on the uplink but relatively loss/latency tolerant traffic on the downlink, etc.) can make a skip indication to the current AP using the procedures described herein.

In some embodiments, once a STA has transmitted a skip indication to the current AP, the STA can switch channels to the target AP after sending a roam request. In embodiments such as these, the STA can also wait on the current AP's channel for a specific period of time prior to switching to avoid a race condition.

In some embodiments, once the STA is on the target AP's channel, the STA can either indicate to the target AP to start its downlink transmission to the STA, or the STA can send an uplink frame to implicitly make the indication.

It should be understood that any of the information items described in the present disclosure can be transmitted together or separately. It should also be understood that any of the information items described in the present disclosure can be transmitted as a part of any existing frame/element/field/subfield in the or can be transmitted a part of any newly defined frame/element/field/subfield.

As previously noted, various embodiments of the present disclosure provide mechanisms for handling QoS monitoring at the AP side.

In some embodiments, a STA can transmit timing information to an AP to guide the AP's scheduler. For example, the STA may transmit any of the examples of timing information shown in Table 6.

TABLE 6
Examples of timing information that can be shared by a STA

| Information item | Description |
|---|---|
| Enqueue/arrival | One or more information item(s) that can convey the enqueue/arrival |
| information | time information (e.g., enqueue time, arrival time, etc.). |
| Expiration | One or more information item(s) that can convey the expiration time |
| information | information (e.g., expiration time). |
| Delay information | One or more information item(s) that can indicate the information on |
| | the delay that a packet faces or can face in the queue (e.g., HOL delay, |
| | queuing delay, total latency, etc.). |
| Correction factor | One or more information item(s) that can indicate how the AP can |
| | correct its scheduling (e.g., an amount of time by which the AP can |
| | prepone its triggers). |

In some embodiments, timing information can be transmitted for a currently transmitted frame. In embodiments such as these, the timing information can be included along with the currently transmitted frame.

In some embodiments, timing information can be transmitted for a frame transmitted in the past (e.g., one or more frames or a statistic that covers one or more frames that were transmitted in the past).

In some embodiments, a STA can report timing information in a timing information report message that can contain at least one or more of the information items as indicated in Table 7.

TABLE 7
Information items that can be present in a timing information report message

| Information item | Description |
|---|---|
| Timing | One or more information item(s) that can indicate the timing |
| information | information (e.g., as indicated in Table 6). |
| Stream identifier | One or more information item(s) that can indicate a stream identifier |
| | (e.g., SCS ID). |
| Session identifier | One or more information item(s) that can indicate a session (e.g., TWT |
| | ID). |
| Packet indicator | One or more information items(s) that can indicate which packet the |
| | timing information corresponds to (e.g., a past packet, the current |
| | packet or an enqueued packet). |

In some embodiments, the information items of Table 7 can be transmitted in one or more of the following ways:
1. A-control field
2. QoS control field
3. Independent frame
4. Modified MAC header

In some embodiments, the information items of Table 7 can be transmitted on a per packet basis, or a statistic can be transmitted for a number of packets (e.g., an average value computed over the past 10 packets).

In some embodiments, the STA and the AP can agree to share timing information by using a setup mechanism. For example, in some embodiments, the STA can transmit a request message to the AP to request the AP to accept timing information from the STA. In embodiments such as these, upon being requested, the AP can transmit a response message to the STA to indicate to the STA that the AP has accepted the STA's request. Once authorized to provide timing information, the STA can then transmit the timing information to the AP.

In some embodiments, when the AP receives timing information, the AP can compute if the AP is meeting the STA's requirements or requests. In embodiments such as these, the AP can then adjust the AP's triggers accordingly. For example, the AP can transmit triggers in advance to match with the arrival times of the packets or to reduce the queuing delay.

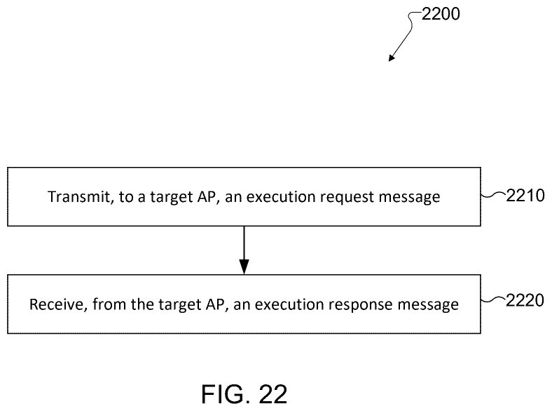

FIG. 22 illustrates an example method for seamless roaming support in next generation WLANs 2200 according to embodiments of the present disclosure. An embodiment of the method illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a method for seamless roaming support in next generation WLANs could be used without departing from the scope of this disclosure.

In the example of FIG. 22, the method begins at step 2210. At step 2210, a STA (such as STA 602, STA 702, STA 802, or STA 902) transmits, to a target AP (such as AP 606, AP 706, AP 806, or AP 906), an execution request message.

At step 2220, the STA receives, from the target AP, an execution response message. In some embodiments, the execution response message may include a field indicating a rejected execution. In embodiments such as these, the rejected execution may be due to at least one of (i) violation of a timeout criterion and (ii) lack of preparation of the target AP.

In some embodiments, before the STA transmits the execution request message, the STA may (i) transmit, to the target AP, a preparation request message, and (ii) receive, from the AP a preparation response message. In embodiments such as these, the preparation request message may be a link reconfiguration request frame including at least one of (i) a context pull indication, (ii) an identifier of the current AP of the STA, and (iii) an indication of context to be pulled, and the preparation response message may be a link reconfiguration response frame including at least one of (i) a pulled context indication, and (ii) one or more operation parameters.

In some embodiments, the execution request message may initiate a transfer of context of the STA from the current AP to the target AP.

In some embodiments, a preparation request message may be included in the execution request message, and a preparation response message may be included in the execution response message.

In some embodiments, the STA may receive, from the current AP of the STA, a BTM request including a list of APs prepared for the STA to roam to, and a recommendation of an AP for the STA to roam to. In embodiments such as these, the STA may transmit the execution request message to the target AP based on the BTM request.

In some embodiments, the STA may receive, from the target AP, a message indicating support for a preparation procedure performed directly with the target AP. In embodiments such as these, based on the indication of support for the preparation procedure, the STA may transmit a preparation message to the target AP.

In some embodiments, the STA may determine whether an RSSI of the current AP of the AP has degraded. In response to a determination that the RSSI for the current AP of the STA has degraded, the STA may roam to the target AP, and transmit the execution request message after the STA has roamed to the target AP.

Although FIG. 22 illustrates one example method for seamless roaming support in next generation WLANs 2200, various changes may be made to FIG. 22. For example, while shown as a series of steps, various steps in FIG. 22 could overlap, occur in parallel, occur in a different order, occur any number of times, be omitted, or replaced by other steps.

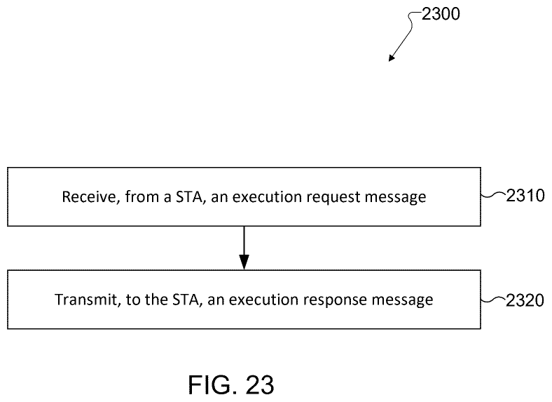

FIG. 23 illustrates another example method for seamless roaming support in next generation WLANs 2300 according to embodiments of the present disclosure. An embodiment of the method illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of a method for seamless roaming support in next generation WLANs could be used without departing from the scope of this disclosure.

In the example of FIG. 23, the method begins at step 2310. At step 2310, a target AP (such as AP 606, AP 706, AP 806, or AP 906) receives, from a STA (such as STA 602, STA 702, STA 802, or STA 902), an execution request message.

At step 2320, the target AP transmits, to the STA, an execution response message. The target AP is part of a seamless roaming mobility domain of a current AP of the STA (such as AP 604, AP 704, AP 804, or AP 804). In some embodiments, the execution response field may include a field indicating a rejected execution. In embodiments such as these, the rejected execution may be due to at least one of (i) violation of a timeout criterion and (ii) lack of preparation of the target AP.

In some embodiments, the target AP may receive, from the STA, a preparation request message, and transmit, to the STA, a preparation response message. In embodiments such as these, the preparation request message may be a link reconfiguration request frame including at least one of (i) a context pull indication, (ii) an identifier of the current AP of the STA, and (iii) an indication of context to be pulled, and the preparation response message may be a link reconfiguration response frame including at least one of (i) a pulled context indication, and (ii) one or more operation parameters.

In some embodiments, the execution request message may initiate a transfer of context of the STA from the current AP of the STA to the target AP.

In some embodiments, a preparation request may be included in the execution request message, and a preparation response message may be included in the execution response message.

In some embodiments, the target AP may transmit, to the STA, a message indicating support for a preparation procedure performed directly with the AP. In embodiments such as these, the target AP may receive a preparation message from the STA in response to the indication of support for the preparation procedure.

Although FIG. 23 illustrates one example method for seamless roaming support in next generation WLANs 2300, various changes may be made to FIG. 23. For example, while shown as a series of steps, various steps in FIG. 23 could overlap, occur in parallel, occur in a different order, occur any number of times, be omitted, or replaced by other steps.

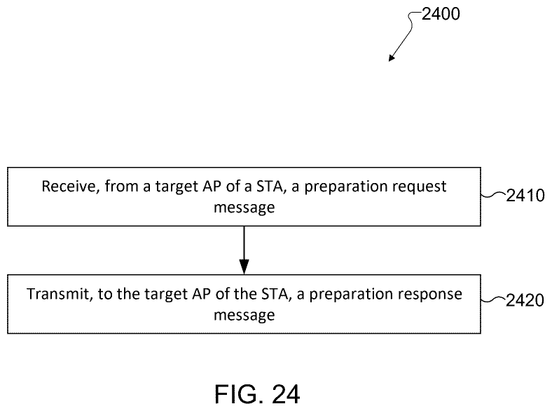

FIG. 24 illustrates another example method for seamless roaming support in next generation WLANs 2400 according to embodiments of the present disclosure. An embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of a method for seamless roaming support in next generation WLANs could be used without departing from the scope of this disclosure.

In the example of FIG. 24, the method begins at step 2410. At step 2410, a current AP (such as AP 604, AP 704, AP 804, or AP 804) of a STA (such as STA 602, STA 702, STA 802, or STA 902) receives, from a target AP (such as AP 606, AP 706, AP 806, or AP 906) of the STA, a preparation request message.

At step 2420, the current AP of the STA transmits, to the target AP of the STA, a preparation response message. The target AP of the STA is part of a seamless roaming mobility domain of the current AP of the STA.

In some embodiments, the current AP of the STA may receive, from the target AP, a context pull request message, and transmit, to the target AP, a context pull response message.

In some embodiments, the preparation request message may include a context pull request message, and the preparation response message may include a context pull response message.

In some embodiments, the preparation request message may be a link reconfiguration request frame including at least one of (i) a context pull indication, (ii) an identifier of the current AP of the STA, and (iii) an indication of context to be pulled, and the preparation response message may be a link reconfiguration response frame including at least one of (i) a pulled context indication, and (ii) one or more operation parameters. In some embodiments, the operation parameters may include at least one of stream classification service (SCS) parameters and emergency preparedness communication services (EPCS) parameters.

In some embodiments, the target AP of the STA may transmit to the STA a BTM request including at least one of a list of APs prepared for the STA to roam to, and a recommendation of an AP for the STA to roam to.

Although FIG. 24 illustrates one example method for seamless roaming support in next generation WLANs 2400, various changes may be made to FIG. 24. For example, while shown as a series of steps, various steps in FIG. 24 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A station (STA) comprising:
a processor; and
a transceiver operably coupled to the processor, the transceiver configured to:
transmit, to a target access point (AP), an execution request message; and
receive, from the target AP, an execution response message,
wherein the target AP is part of a seamless roaming mobility domain of a current AP of the STA.

2. The STA of claim 1, wherein the execution response message includes a field indicating a rejected execution.

3. The STA of claim 2, wherein the rejected execution is due to at least one of (i) violation of a timeout criterion and (ii) lack of preparation of the target AP.

4. The STA of claim 1, wherein the transceiver is further configured to, prior to transmission of the execution request message:
transmit, to the target AP, a preparation request message; and
receive, from the target AP, a preparation response message.

5. The STA of claim 4, wherein:
the preparation request message is a link reconfiguration request frame including at least one of (i) a context pull indication, (ii) an identifier of the current AP of the STA, and (iii) an indication of a context to be pulled; and
the preparation response message is a link reconfiguration response frame including at least one of (i) a pulled context indication and (ii) one or more operation parameters.

6. The STA of claim 1, wherein the execution request message initiates a transfer of context of the STA from the current AP to the target AP.

7. The STA of claim 1, wherein:
a preparation request message is included in the execution request message; and
a preparation response message is included in the execution response message.

8. The STA of claim 1, wherein:
the transceiver is further configured to receive, from the current AP of the STA, a basic service set (BSS) transition management (BTM) request including at least one of:
a list of APs prepared for the STA to roam to; and
a recommendation of an AP for the STA to roam to; and
the processor is configured to cause the transceiver to transmit the execution request message to the target AP based on the BTM request.

9. The STA of claim 1, wherein the transceiver is further configured to:
receive, from the target AP, a message indicating support for a preparation procedure performed directly with the target AP; and
based on the indication of support for the preparation procedure, transmit a preparation message to the target AP.

10. The STA of claim 1, wherein the processor is configured to:
determine whether a received signal strength indicator (RSSI) for the current AP of the STA has degraded;
in response to a determination that the RSSI for the current AP of the STA has degraded, cause the STA to roam to the target AP; and
cause the transceiver to transmit the execution request message after the STA has roamed to the target AP.

11. An access point (AP) comprising:
a processor; and
a transceiver operably coupled to the processor, the transceiver configured to:
receive, from a station (STA), an execution request message; and
transmit, to the STA, an execution response message,
wherein the AP is part of a seamless roaming mobility domain of a current AP of the STA.

12. The AP of claim 11, wherein the execution response message includes a field indicating a rejected execution.

13. The AP of claim 12, wherein the rejected execution is due to at least one of (i) violation of a timeout criterion and (ii) lack of preparation of the AP.

14. The AP of claim 11, wherein the transceiver is further configured to, prior to reception of the execution request message:
receive, from the STA, a preparation request message; and
transmit, to the STA, a preparation response message.

15. The AP of claim 14, wherein:
the preparation request message is a link reconfiguration request frame including at least one of (i) a context pull indication, (ii) an identifier of the current AP of the STA, and (iii) an indication of a context to be pulled; and
the preparation response message is a link reconfiguration response frame including at least one of (i) a pulled context indication and (ii) one or more operation parameters.

16. The AP of claim 11, wherein the execution request message initiates a transfer of context of the STA from the current AP of the STA to the AP.

17. The AP of claim 11, wherein:
a preparation request message is included in the execution request message; and
a preparation response message is included in the execution response message.

18. The AP of claim 11, wherein the transceiver is further configured to:
transmit, to the STA, a message indicating support for a preparation procedure performed directly with the AP; and
receive a preparation message from the STA in response to the indication of support for the preparation procedure.

19. An access point (AP) comprising:
a processor; and
a transceiver operably coupled to the processor, the transceiver configured to:
receive, from a target AP of a station (STA), a preparation request message; and
transmit, to the target AP of the STA, a preparation response message,
wherein the AP is a current AP of the STA, and the target AP of the STA is part of a seamless roaming mobility domain of the AP.

20. The AP of claim 11, wherein:
the transceiver is further configured to transmit, the STA, a basic service set (BSS) transition management (BTM) request including at least one of:
a list of APs prepared for the STA to roam to; and
a recommendation of an AP for the STA to roam to.
